(19) United States
(12) Patent Application Publication
(10) Pub. No.: US 2022/0246341 A1
(43) Pub. Date: Aug. 4, 2022

(54) MAGNETIC COMPONENT

(71) Applicant: Schaffner EMV AG, Luterbach (CH)

(72) Inventors: Stefanos Panagiotis GRANITSAS, Zuchwil (CH); Roberto MRAD, Zuchwil (CH); Rémy CAILLAUD, Zuchwil (CH)

(21) Appl. No.: 17/589,388

(22) Filed: Jan. 31, 2022

(30) Foreign Application Priority Data
Feb. 2, 2021 (EP) 21154878.9

(51) Int. Cl. H01F 27/02; H01F 27/29; H01F 27/28; H01F 27/26

(52) U.S. Cl. CPC H01F 27/022; H01F 27/266; H01F 27/2823; H01F 27/29

(57) ABSTRACT

A magnetic component comprising one or more wound magnetic cores in a housing and held stationary in the housing by a solid potting mass, characterized in that the housing has one open top face and at least one open side, the potting mass having a top boundary parallel to the open top face and at least one side boundary adjacent to or coincident with the at least one open side. The inventive component can be fabricated by closing the open sides with barriers to create a cavity with an open top and fluid-tight bottom that can be filled with potting and hold the wound core cores.

### REFERENCE DATA

The present application claims priority of European patent application EP21154878 of Feb. 2, 2021, the contents whereof are entirely incorporated.

### TECHNICAL DOMAIN

The present invention concerns a magnetic component and a manufacturing method thereof. Embodiments of the invention include, among others, inductors, polyphase inductors, coupled inductors, chokes for electromagnetic compatibility filters, common mode chokes, reactors, and power transformers. The invention is not limited to these examples, however.

### RELATED ART

Magnetic components are key elements of electric engineering and power electronics. They are found in a wide range of applications in all industrial sectors. Inductors, for example are used, in filter, voltage converters, in power factor compensation, or as current-limiting reactors. Advanced noise filters often include common mode chokes (also known as current-compensated chokes), with two windings configured in a way that the flux of differential-mode currents cancel each other. Transformers are another important example of magnetic component with coupled inductances.

Besides their electrical characteristics, magnetic components must also fulfil specifications for dimensions, voltage, current, and power rating, losses, heat resistance, immunity to vibrations, and many other parameters. In automotive applications, where electrical components are more and more common, these specifications are especially stringent. As a result, despite the apparent simplicity of the underlying electric circuit, inductors are complex products that are difficult to design and customize to all the possible applications.

A state-of the art magnetic component is the result of a trade-off between the desired nominal inductance value, the size, weight, and footprint dictated by the desired application, the choice of material, layout, and cooling.

It is known to house magnetic components into metallic envelopes to improve the heat exchange. It is also known to encapsulate magnetic component in potting compounds to further improve the heat exchange and provide resistance against vibrations.

The housing is the mechanical and thermal interface between the magnetic component and the system in which it is embedded. Clearances between the component and housing should be kept to a minimum for a lower thermal resistance, and the dimensional tolerances of the housing must be strictly controlled. On the other hand, eddy currents may induce additional losses if the conductive housing is very close to the magnetic component. Potting requires a cavity in the housing with a fluid-tight bottom, conventionally obtained by complex metalworking processes such as stamping, deep-drawing, die-casting, welding and/or machining. Such housings are expensive, bulky, and contribute significantly to the cost.

### SHORT DISCLOSURE OF THE INVENTION

An aim of the present invention is the provision of a magnetic component overcoming the shortcomings and limitations of the state of the art and a corresponding fabrication process.

According to the invention, these aims are attained by the object of the attached claims, and especially by a magnetic component comprising one or more magnetic circuits concatenated with electric windings contained in a housing and held stationary in the housing by a solid potting mass, characterized in that the housing has one open top face and at least one open side, the potting mass having a top boundary parallel to the open top face and at least one side boundary adjacent to or coincident with the at least one open side.

The inventive object is attainable as well by a method of fabricating a magnetic component comprising: providing a housing configured as an open trough with an open top and at one open side or a plurality of open sides; closing the open side or the plurality of open sides with a removable barrier or barriers to create a temporary cavity with an open top and fluid-tight bottom and sides, positioning one or more magnetic circuits with concatenated electric windings in the temporary cavity, pouring a curable potting compound in the temporary cavity and submerging at least partially the magnetic circuits and/or the electric winding in the curable potting compound, causing the curable potting compound to cure and solidify, removing the removable barrier or barriers.

Dependent claims deal with important and useful, but not essential, features. These include the fact that the housing may be configured as an open trough with two mutually opposed open sides, each adjacent to or coincident with a side boundary of the potting mass, the potting mass englobing partially the magnetic circuits and/or the electric windings concatenated thereto, such at least part of the magnetic circuits and/or part of the electric windings is in air, the use of section of a metallic extrusion, for example an aluminium extrusion as housing, the nature of the magnetic cores that may comprise one or more of: ferrite, powdered magnetic alloy, iron powder, amorphous or nanocrystalline ferromagnetic material, laminated magnetic steel, and of the windings' conductor, which may be Litz or stranded conductors, solid conductors, aluminium wire, copper wire, silver wire, wherein the section of the conductor may be round, flat, rectangular, or keystone. The potting mass may be of epoxy, polyurethane or silicone composition, or indeed any suitable material capable of being solidified.

The magnetic device of the invention has at least one core with at least one winding concatenated thereto. Changing the number of cores and winding one can obtain the whole gamut of magnetic devices: monophase and multiphase inductors, coupled inductors, common-mode chokes, transformers, and so on.

With respect to what is known in the art, the invention provides a lower manufacturing cost, because a housing with open ends is simpler to manufacture: plain “U” shapes can be realized very economically by bending metal sheets, and more complex forms can still be achieved by extrusion. Both these processes are cheaper than stamping, drawing, casting or machining metal parts, yield excellent dimensional tolerances and thin walls, thus a lower weight of the final component. The weight is even further reduced since at least two walls are omitted.

The invention may yield a superior heat dissipation, since the extruded housing can be manufactured in a shape following that of the magnetic cores and windings, at minimal distance. The eddy losses are also essentially cancelled, because the housing of the device is open on the same sides on which the winding come out of the core. The absence of a conductive wall on the open sides of the housing also simplifies the electrical insulation, especially for what creeping discharges are concerned.

### SHORT DESCRIPTION OF THE DRAWINGS

Exemplar embodiments of the invention are disclosed in the description and illustrated by the drawings in which:

FIG. 1 illustrates schematically a single-phase choke according to an aspect of the invention, with two temporary fixtures using during the manufacturing.

FIG. 2 shows a three-phase choke according to an aspect of the invention.

FIG. 3 shows a choke of the invention during the production, before the pouring of the potting compound, seen from one of the open faces of the housing.

FIG. 4 shows an embodiment of the invention consisting in a power transformer with two windings on a pair of E-cores.

FIG. 5 shows the device of FIG. 4, exploded in its constituent parts.

### EXAMPLES OF EMBODIMENTS OF THE PRESENT INVENTION

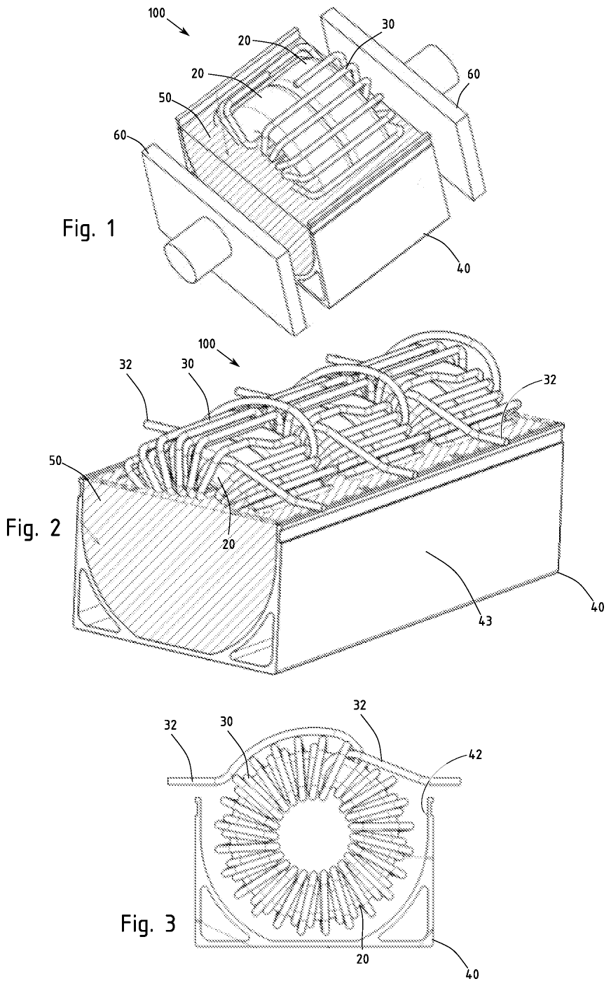

With reference to FIG. 1, an embodiment of the invention is a single-phase choke, or inductor with a coil comprising a toroidal core (here with two superposed toroids 20) and a winding 30 concatenated thereto, generating an inductance. The toroids 20 and the winding 30 are lodged in a housing 40 constituted by a segment of extruded aluminium that has a channel with an inner cylindrical surface corresponding to the general shape of the cores, such that the gap between the active magnetic part and the housing is minimal and, when filled with potting compound 50, present a minimal thermal resistance. The potting compound 50 is a liquid or uncured state of the potting mass 50.

Since the housing has the shape of a channel 42 (visible in FIG. 3) with two open faces, the production method includes the positioning of two removable barriers 60 that can be placed against the open sides of the channel to close them and create a temporary cavity that can contain the potting compound 50 in liquid or uncured state.

In FIG. 1, the removable barriers 60 are shown detached from the magnetic component to show the potting mass 50 inside. In the production method of the invention, the barriers are tightly placed against the open faces of the housing, the coil or coils are positioned along the axis of the channel 42 in the intended position and the potting compound 50 is poured in the housing and caused to solidify. Once the potting compound 50 is cured, the removable barriers 60 can be removed and reused in the production of another unit.

In a possible variant, the barriers 60 are not removable but designed to bond permanently to the potting mass 50. The barriers in this case may be light plastic elements that do not add appreciably to the final weight and cost. Such sacrificial barriers may also have additional useful features such as: spacing means keeping the coils separated from the walls of the channel 42, support means for the terminals 32, holes or other forms of mechanical interface for affixing the magnetic device 100 at a desired location, electric connectors for inserting the magnetic device in a circuit, and so on.

The fluid-tight connection between the removable barriers 60 and the housing 40 can be obtained by interposing a rubber sheet or gaskets, or in any other suitable way. Preferably, the removable barriers are made of a low-adhesion material like PTFE or has a surface layer of such a low-adhesion material on surface to ease the separation between the barrier and the housing. To the same purpose, the removable barriers may also be coated with a release fluid containing for example fluorinated oil, silicone oil, or mineral oil.

FIG. 2 shows another variant of the invention that embodies a three-phase magnetic inductor that could be used in a power-factor compensation unit, in a filter, or in any other suitable use case. The cross-section of this device is the same as, or very close to, that of the previous embodiment, but the segment of extrusion 40 is longer to accommodate three wound cores 20 in the channel. Importantly, the magnetic cores emerge in part above the potting mass 50 rather than being completely englobed therein, which reduces the weight and may simplify the forming and creation of the electrical terminals 32. If desired, however, the cores and winding could be immersed completely by increasing the height of the side walls 43.

FIG. 3 is another view of the device of FIG. 2, from an open side, without the potting mass 50. It can be appreciated that the core 20 and windings 30 are disposed along the longitudinal axis of the enclosure 40 with a minimal and well-controlled distance to the walls of the enclosure. The enclosure can be easily manufactured in a variety of forms, for example to interface to an external heat sink or to respect customer specifications.

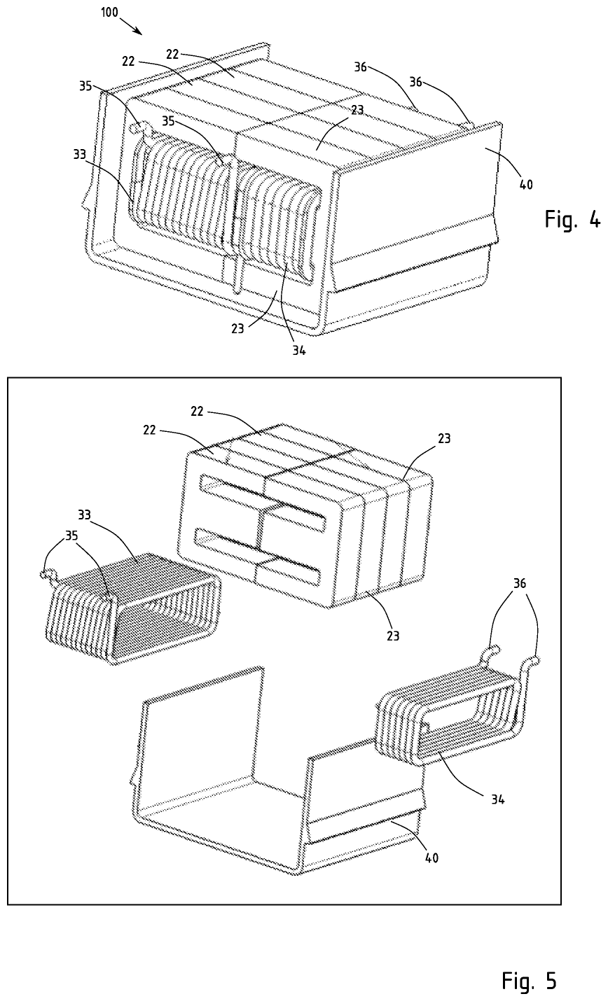

FIG. 4 illustrates another embodiment in which the core, rather than toroidal, is split into multiple elements 22, 23 that can be juxtaposed to create a magnetic circuit. A “E-E” core is represented here, but the invention is not limited thereto. The magnetic device in this embodiment is a power transformer with a primary winding 33 and a secondary winding 34. As the core is split, the windings can be wound separately and slid onto the central legs of the “E” elements for easier manufacturing. In this example the windings are freestanding, but they may be coiled on bobbins if needed.

Advantageously, the terminals of the primary winding 35 and the terminal of the secondary winding 36 are routed towards the opposite open ends of the housing, where there are no metallic walls, thereby simplifying the insulation problems.

This variant of realization lends itself also to the realization of inductors, current-compensated chokes, Power-factor correction reactors, or any other magnetic, filtering, or electronic components.

Since the EE cores 22 and 23 yield a prismatic shape when assembled, the housing 40 is preferably configured as an open rectangular channel in which the wound core elements 22, 23 are tightly contained. In this construction the electric windings 33, 34 are held spaced from the metallic walls by the structure of the core itself. The insulation distance between windings and housing is automatically guaranteed. Core elements 22, 23, if nonconducting, can be placed in direct contact with the housing 40.

FIG. 5 shows the device of FIG. 4 with the separate components exploded. The potting mass has not been drawn to improve the legibility of the drawing.

In addition to the two form of magnetic cores demonstrated above, the invention could be realized with cores of any other shape.

### REFERENCE SYMBOLS IN THE FIGURES

20 core
22 core element
23 core element
30 winding
32 terminal
33 primary winding
34 secondary winding
35 primary terminals
36 secondary terminals
40 housing, extrusion
42 channel
43 side walls
50 potting mass, potting compound
60 barrier or barriers, removable barrier or barriers
100 magnetic device, magnetic component

1. A magnetic component comprising one or more magnetic circuits concatenated with electric windings contained in a housing and held stationary in the housing by a solid potting mass, wherein the housing has one open top face and at least one open side, the potting mass having a top boundary parallel to the open top face and at least one side boundary adjacent to or coincident with the at least one open side.

2. The magnetic component of claim 1, the housing being configured as an open trough with two mutually opposed open sides, each adjacent to or coincident with a side boundary of the potting mass.

3. The magnetic component of claim 1, wherein the potting mass englobes partially the magnetic circuits and/or the electric windings concatenated thereto, whereby at least part of the magnetic circuits and/or part of the electric windings is in air.

4. The magnetic component of claim 1, wherein the housing is an extruded metallic element, for example an aluminium extruded element.

5. The magnetic component of claim 1, wherein the magnetic circuits comprise one or more of: ferrite, powdered magnetic alloy, iron powder, amorphous or nanocrystalline ferromagnetic material, laminated magnetic steel.

6. The magnetic component of claim 1, wherein the windings include one or more of: Litz conductors, stranded conductors, solid conductors, aluminium wire, copper wire, silver wire, wherein the section of the conductor is round, flat, or keystone.

7. The magnetic component of claim 1, wherein the potting mass comprises a curable resin of epoxy, polyurethane or silicone composition.

8. A method of fabricating a magnetic component comprising: providing a housing configured as an open trough with an open top and at one open side or a plurality of open sides; closing the open side or the plurality of open sides with a barrier or barriers to create a cavity with an open top and fluid-tight bottom and sides, positioning one or more magnetic circuits with concatenated electric windings in the temporary cavity, pouring a curable potting compound in the temporary cavity and submerging at least partially the magnetic circuits and/or the electric windings in the curable potting compound, causing the curable potting compound to cure and solidify.

9. The method of claim 8, wherein the housing is a segment of an aluminium extrusion or of a metallic extrusion.

10. The method of claim 8, wherein the potting mass englobes partially one or more magnetic circuits and/or the electric windings concatenated thereto, whereby at least part of the one or more magnetic circuits and/or part of the electric windings is in air.

11. The method of claim 8, wherein the one or more magnetic circuits comprise one or more of: ferrite, powdered magnetic alloy, iron powder, amorphous or nanocrystalline ferromagnetic material, laminated magnetic steel.

12. The method of claim 8, wherein the electric windings include one or more of: Litz conductors, stranded conductors, solid conductors, aluminium wire, copper wire, silver wire, wherein the section of the conductor is round, flat, or keystone.

13. The method of claim 8, wherein the potting mass comprises a curable resin of epoxy, polyurethane or silicone composition.

14. The method of claim 8, comprising a step of removing the barrier or barriers.

15. The method of claim 8, comprising the step of tightening the connection between the removable barrier or barriers and the housing.

16. The method of claim 8, comprising the step of coting the removable barrier or barriers with a release fluid.
